(19) United States
(12) Patent Application Publication
(10) Pub. No.: US 2009/0288340 A1
(43) Pub. Date: Nov. 26, 2009

(54) LED Grow Light Method and Apparatus

(76) Inventor: Ryan Hess, Oveido, FL (US)

Correspondence Address: LARRY D. JOHNSON, P.O. BOX 470277, CELEBRATION, FL, 34747, US

(21) Appl. No.: 12/472,194

(22) Filed: May 26, 2009

Related U.S. Application Data
(60) Provisional application No. 61/128,786, filed on May 23, 2008.

(51) Int. Cl. A01G 7/00; F21L 4/02; A01G 9/20

(52) U.S. Cl. 47/58.1 LS; 362/157

(57) ABSTRACT

A grow light fixture that may be used for the replacement of high intensity discharge (HID) lamp fixtures used for growing plants includes a housing containing a plurality of both red and blue high power LEDs mounted to a circuit board, and powered by an onboard power supply. Control circuitry may include separate, infinitely variable controls to enable independent adjustment of the red and blue LED light output. A plurality of thermal vias made of copper or other thermally conductive material extend through the circuit board to conduct heat from the LEDs to a heat sink mounted on the back of the circuit board, and a fan may be used to vent the heat to the outside of the housing. The housing is mounted an appropriate distance above a plant in a growth media to provide user-controlled lighting for enhanced plant growth.

### CROSS REFERENCE TO RELATED APPLICATIONS

The present application claims the benefit of the filing date of U.S. Provisional Patent Application Ser. No. 61/128,786, filed May 23, 2008.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to electric lamp fixtures used for growing plants, and more particularly to an improved light emitting diode (LED) grow light method and apparatus.

### BACKGROUND INFORMATION AND DISCUSSION OF RELATED ART

Typical grow light fixtures use high intensity discharge (HID) lamps, which can be costly to manufacture and operate. For example, many HID grow lamps cost thousands of dollars, may consume on the order of 400-1000 watts of electricity, and often produce excessive amounts of heat and noise.

U.S. Pat. No. 6,921,182 to Anderson, Jr., et al. discloses an LED lamp for enhancing commercial and home plant growth, including a first set of orange LEDs with a peak wavelength emission of about 612 nanometers, a second set of red light emitting LEDs with a peak wavelength of about 660 nanometers, and blue light LEDs. Two beam spreads, 15 degrees and 30 degrees, were provided for both the 660 nm LEDs and 612 nm LEDs. When directed perpendicularly upon tops of the plant leaves, 10% light transmission occurred through the leaves for the 30 degree LEDs, and 80% light transmission for the 15 degree LEDs. Thus, Anderson reports that fully 50% of the orange/red spectrum primarily used for photosynthesis was transmitted through the upper leaf canopy, making it available to support photosynthesis in leaves below. Anderson describes positioning LED lamps at varying distances from the growing plants for controlling plant growth rates that vary with these distances, thereby to control plant inventory, because growth of plants can be greatly slowed to preserve them during periods of slow sales.

U.S. Patent Application 20040264195 by Chang, et al. describes a light emitting diode (LED) light source including a printed circuit board, a heat sink, a plurality of heat conductors, and at least one LED chip. The printed circuit board (PCB) has a plurality of holes. The heat sink connects under the PCB for conducting heat. Each heat conductor is formed on the heat sink corresponding to each hole of the PCB for conducting heat, and each heat conductor has a basin on the topside. The LED chip is attached to the basin of the heat conductor.

U.S. Patent Application 20060006820 by Roseman, et al. teaches a horticultural lighting system comprising a light source that emits specific and specialized light spectra and is adjustable through the use of a control interface, which is able to support plants from seedling to mature flowering and fruiting adults. The lighting system utilizes a power source to energize a lighting fixture. A given lighting fixture includes high efficiency luminary devices that may have varying color combinations and spatial arrangements. A substrate provides support and thermal management. Electrical connectors allow multiple lighting fixtures to be connected to a single power source. A switching device allows linear control of intensity, time and color parameters of the emitted light, and is programmable to simulate photoperiods and spectrum shift. Roseman describes the system as being optimized to stimulate growth in plants during times of different light-intensity and light-spectrum needs. The Roseman design takes into consideration various factors so the claimed lighting system is described as operating at the highest possible efficiency and exhibiting the longest possible life.

U.S. Patent Application 20060254135 by Dubuc discloses a method and apparatus for irradiation of plants using light emitting diodes. The method uses LEDs to supplement natural light in a greenhouse and a support structure for attaching LEDs in a greenhouse so that the plants receive substantially even light distribution from the LEDs and minimal natural light is blocked by the lighting system. A narrow attachment rail is used to suspend a strip of LEDs from the frame structure of the greenhouse.

U.S. Patent Application 20070058368 by Partee, et al. describes a high brightness LED system that generates radiometric light energy capable of controlling growth of plants from seed to full maturity. According to one or more aspects of that invention, a unit is disclosed that provides artificial light to promote plant growth. The unit utilizes red and blue light emitting diodes (LEDs) to emit wavelengths of light that are more favorable to plant growth. In particular, blue LEDs are interspersed with red LED's to broadcast a desired range of light. Although the LEDs operate at lower temperatures than conventional artificial light sources and thus allow the unit to be placed closer to plants for more efficient growth, the unit includes a heat sink to disperse even more heat. Separate switches are included to control the red and blue LEDs to allow controlled exposure to different light sources to facilitate desired plant growth.

U.S Patent Application 20070268693 by Crabb, et al. teaches a method and apparatus of lighting a marine habitat for growth utilizing an LED light system. The light system includes an LED light source, a power supply for such light source and a controller for controlling the activation status and the intensity of the LED light source.

The foregoing patents and patent applications reflect the current state of the art of which the present inventor is aware. Reference to, and discussion of, these patents and patent applications is intended to aid in discharging Applicant's acknowledged duty of candor in disclosing information that may be relevant to the examination of claims to the present invention. However, it is respectfully submitted that none of the above-indicated patents and patent applications disclose, teach, suggest, show, or otherwise render obvious, either singly or when considered in combination, the invention described and claimed herein.

### SUMMARY OF THE INVENTION

The LED grow light apparatus of the present invention provides an improved grow light fixture that may be used for the replacement of high intensity discharge (HID) lamp fixtures used for growing plants. The inventive apparatus includes a housing containing a plurality of both red and blue high power LEDs mounted to a circuit board, and powered by an onboard power supply. The combination of red and blue LEDs has been determined to provide an ideal light spectrum for growing plants. Control circuitry may include separate, infinitely variable controls to enable independent adjustment of the red and blue LED light output. A plurality of thermal vias made of copper or other thermally conductive material preferably extend through the circuit board to conduct heat from the LEDs to a heat sink mounted on the back of the circuit board, and a fan may be used to vent the heat to the outside of the housing. The housing is mounted an appropriate distance above a plant in a growth media to provide user-controlled lighting for enhanced plant growth.

The inventive light emitting diode (LED) light fixture can replace an HID lamp consuming several times as much power, while still providing the necessary light energy for photosynthesis and growth through the use of the multiple high power LEDs. The inventive apparatus may be less expensive to manufacture than other LED grow light systems due to the use of the thermal vias, which enables the manufacture of the PCB on a single board.

The optional independent light intensity controls allow the user to adjust the red light spectrum from off to fully-on through an infinite number of steps, and similarly adjust the blue light spectrum from off to fully-on through an infinite number of steps. This enables the user to customize the light spectrum for any plant type, as well as for the different growing stages for a given plant type. Alternatively, the red or blue intensity controls can be omitted for constant maximum light output operation. Also, one or more red and/or one or more blue LEDs can be replaced with white LEDs to supplement the narrow bandwidth of the red and blue LEDs.

The apparatus preferably uses a direct current fan for quiet operation with less vibration, and has an integrated power supply for ease of use and setup.

It is therefore an object of the present invention to provide a new and improved grow light apparatus.

It is another object of the present invention to provide a new and improved LED grow light apparatus that is inexpensive to produce and efficient to use.

A further object or feature of the present invention is a new and improved grow light fixture that enables the user to customize the light spectrum for any plant type, as well as for the different growing stages for a given plant type.

An even further object of the present invention is to provide a novel method for growing plants.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an LED grow light apparatus of the present invention in use above a plant in a growth media;

FIG. 2 is an exploded view of an LED grow light apparatus of this invention;

FIG. 3 is a plan view of an LED mounted on a circuit board, with a plurality of thermal vias in the circuit board for thermal dissipation;

FIG. 4 is a side elevation cross-section view of an LED mounted on a circuit board, with a plurality of thermal vias, this view taken along line 4-4 of FIG. 3;

FIG. 5 is a schematic view of a plurality of red LEDs and blue LEDs arranged in a grid pattern on a circuit board, with the blue LEDs arranged in a generally circular or arcuate pattern;

FIG. 6 is a schematic view of a plurality of LEDs arranged in rows in a grid on the circuit board, illustrating current balancing circuit bridges between the rows of LEDs.

### DRAWING REFERENCE NUMERALS

11 light fixture
12 enclosure
13 fan
14 heal sink
15 circuit board
16 LEDs
17 power supply circuitry
18 optical window
19 growing media
20 end plate
21 chains for hanging light fixture
22 beam for support
23 plant
24 thermal vias
25 control knobs
32 grid pattern
40 row of LEDs
42 circuit bridge
R red LEDs
B blue LEDs

### DETAILED DESCRIPTION OF THE INVENTION

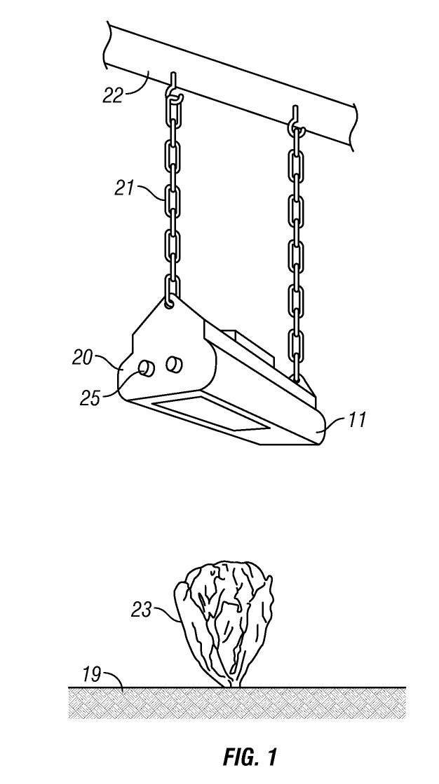

Referring to FIGS. 1 through 6, wherein like reference numerals refer to like components in the various views, there is illustrated therein a new and improved LED grow light apparatus, generally denominated 11 herein.

FIG. 1 is a perspective view of an LED grow light apparatus of the present invention in use. Light fixture 11 may be mounted to an existing support beam 22 or other structure by chains 21. Red and blue light spectrum intensity may be controlled by control knobs 25 preferably mounted on end plate 20, and light is emitted onto plant 23 in grow media 19.

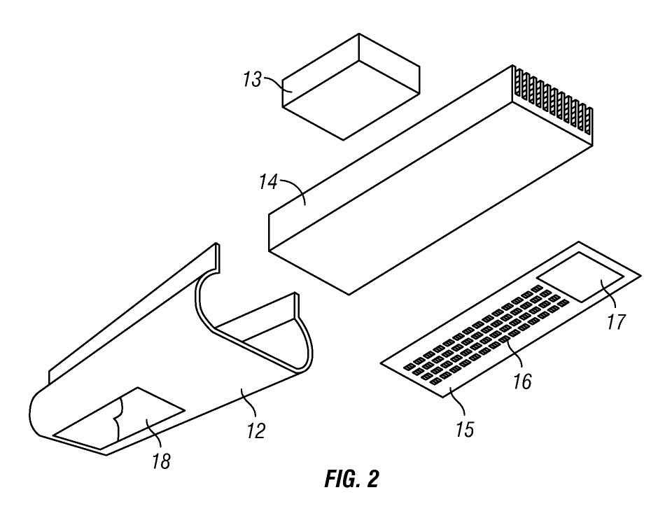

FIG. 2 is an exploded view of an LED grow light apparatus of this invention. The light fixture 11 includes a plurality of high power (e.g., 2 watts or more) light emitting diodes 16 secured to a printed circuit board 15. For example, 40 high power red LEDs (heaving a peak wavelength of 635 nm) and 16 high power blue LEDs (having a peak wavelength of 450 nm) such as Xlamp LEDs manufactured by Cree may be arrayed in a grid on the circuit board 15. Heat sink 14 may be mounted to the back of circuit board 15 to dissipate the heat generated by the LEDs. A fan 13, preferably operating on direct current, may be attached to the heat sink 14 for active cooling. An integrated power supply 17, preferably mounted to the circuit board 15, provides the LEDs 16 with a constant current, which is user adjustable through control knobs 25. An enclosure 12 surrounds the components of the light fixture. An optical window 18 allows light from the LEDs 16 to exit the light fixture to the growing plant.

The ability to adjust the current to the LEDs enables adjustment of the intensity of the plurality of red and blue high power LEDs. In the preferred embodiment, the control means enables independent adjustment of the intensity of the red high power LEDs and blue high power LEDs to adjust the red spectrum from off to fully on through an infinite number of steps and to adjust the blue spectrum from off to fully on through an infinite number of steps, or to adjust the red spectrum from off to fully on through an infinite member of steps while independently adjusting the blue spectrum from off to fully on through an infinite number of steps.

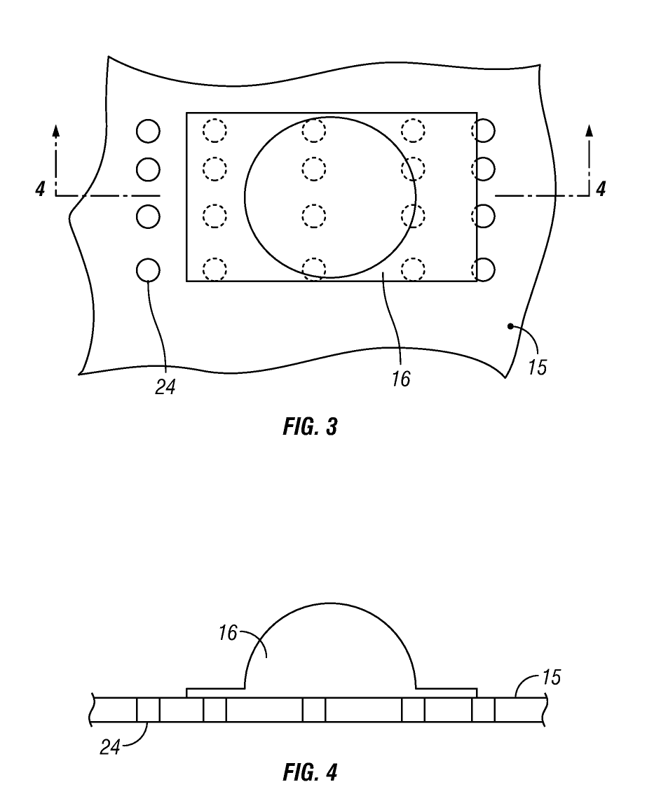

FIG. 3 is a plan view of an LED 16 mounted on a circuit board 15, with a plurality of thermally conductive plated-through-hole copper vias 24 to efficiently conduct heat from the LEDs on one side of the board to the heat sink on the other side of the board. The LEDs may be installed as original equipment by the manufacturer of the apparatus, or may be provided to the end user for installation or replacement on the circuit board as necessary.

FIG. 4 is a side elevation cross-section view of an LED 16 mounted on circuit board 15, with a plurality of copper vias 24, this view taken along line 4-4 of FIG. 3. Each LED is associated with at least one, and preferably several (e.g. up to 25 or more) thermally conductive vias. Use of the thermal vias also allows the manufacture of the PCB on a single board.

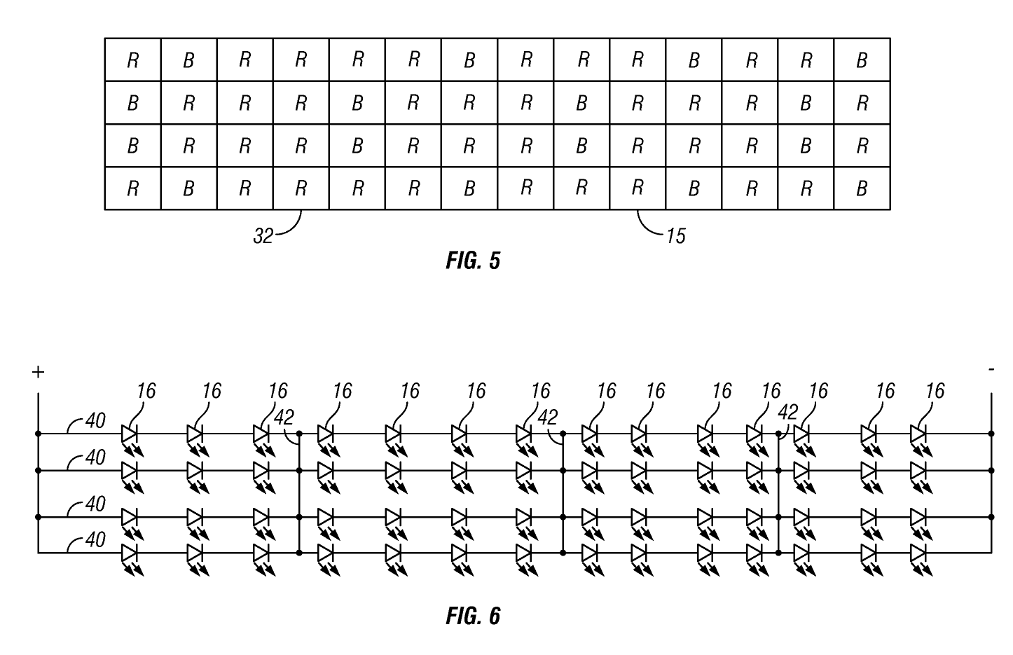

FIG. 5 is a schematic view of a plurality of 40 red LEDs R and 16 blue LEDs B arranged in a grid pattern 32 on a circuit board 15. In the preferred embodiment, the blue LEDs B are arranged in a generally circular or arcuate pattern within the grid in the field of red LEDs R. This arrangement provides a desirable balance of the distinct red and blue wavelengths delivered to the plant growth below.

FIG. 6 is a schematic view of a plurality of LEDs 16 arranged in a grid on the circuit board 15. The circuitry is typically arranged such that the power supply delivers a constant current of, e.g., 2.8 amps. The current is then split into four parallel rows 40 of LEDs, at 0.7 amps each. Because of the nature of LEDs, and their variability between batches, rather than having four rows only connected at the two ends of the rows, circuit bridges 42 are periodically installed across the rows to level the voltage between the rows, in a “ladder” arrangement. For example, after the current in the rows goes through some number or combination of LEDs (e.g., three red LEDs and a blue LED), a current balancing bridge is placed between the rows.

The above disclosure is sufficient to enable one of ordinary skill in the art to practice the invention, and provides the best mode of practicing the invention presently contemplated by tie inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A grow light apparatus comprising:
a housing;
a plurality of red and blue high power LEDs mounted to a circuit board in said housing;
a power supply connected to said plurality of red and blue high power LEDs; and
a heat sink mounted on the back of said circuit board, wherein said housing is mounted an appropriate distance above a plant in a growth media to provide user-controlled lighting for enhanced plant growth.

2. The grow light apparatus of claim 1 including a plurality of thermally conductive vias extending through said circuit board to conduct heat from said plurality of red and blue high power LEDs.

3. The grow light apparatus of claim 2 wherein said plurality of thermally conductive vias comprise plated-through-hole copper vias.

4. The grow light apparatus of claim 2 wherein each of said plurality of red, and blue high power LEDs is associated with at least one thermally conductive via.

5. The grow light apparatus of claim 1 further including control means to enable adjustment of the intensity of said plurality of red and blue high power LEDs.

6. The grow light apparatus of claim 5 wherein said control means enable independent adjustment of the intensity of the red high power LEDs and blue high power LEDs to adjust the red spectrum from off to fully on through an infinite number of steps and to adjust the blue spectrum from off to fully on through an infinite number of steps.

7. The grow light apparatus of claim 5 wherein said control means enable independent adjustment of the intensity of the red high power LEDs independently of the intensity of the blue high power LEDs to adjust the red spectrum from off to fully on through an infinite number of steps while independently adjusting the blue spectrum from off to fully on through an infinite number of steps.

8. The grow light apparatus of claim 1 wherein said plurality of red and blue high power LEDs comprises 40 red LEDs and 16 blue LEDs.

9. The grow light apparatus of claim 1 wherein said blue high power LEDs are arranged in a generally circular pattern within a grid.

10. The grow light apparatus of claim 1 wherein said red and blue high power LEDs are arranged in a grid having a plurality of rows, and said power supply includes circuit means to split the current generally equally into each of said rows.

11. The grow light apparatus of claim 10 further including at least one bridging connection between at least two of said rows to equalize current to said plurality of red and blue high power LEDs.

12. The grow light apparatus of claim 1 further including a fan attached to said heat sink.

13. The grow light apparatus of claim 12 wherein said fan is powered by direct current.

14. The grow light apparatus of claim 1 wherein said plurality of red and blue high power LEDs comprise LEDs having a light output of 2 watts or greater.

15. The grow light apparatus of claim 1 wherein said plurality of red and blue high power LEDs and said power supply are mounted on a single printed circuit board.

16. A method for growing plants comprising:
providing a grow light apparatus including a housing, a plurality of red and blue high power LEDs mounted to a circuit board in the housing, and a power supply for the LEDs;
mounting the grow light apparatus an appropriate distance above a plant in a growth media; and
adjusting the intensity of the plurality of red and blue high power LEDs to facilitate plant growth.

17. The method for growing plants of claim 16 further including independently adjusting the intensity of the red high power LEDs and the blue high power LEDs to allow the user to adjust the red light spectrum from off to fully on through an infinite number of steps, and adjust the blue light spectrum from off to fully on through an infinite number of steps, to enable the user to customize the light spectrum for any plant type, as well as for the different growing stages for a given plant type.

18. The method for growing plants of claim 16 further including connecting a heat sink to the circuit board to dissipate heat generated by the LEDs.

19. The method for growing plants of claim 18 further including attaching a fan to the heat sink to facilitate heat dissipation.

20. The method for growing plants of claim 16 further including providing a plurality of thermal vias in the circuit board to facilitate heat transfer from the LEDs to the heat sink.
